(19) United States
(12) Patent Application Publication
(10) Pub. No.: US 2005/0193224 A1
(43) Pub. Date: Sep. 1, 2005

(54) Computer clock management system and method

(76) Inventor: Jian-Ann Chen, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/839,200

(22) Filed: May 4, 2004

(30) Foreign Application Priority Data
Feb. 28, 2004 (CN) 200410015598.8

(51) Int. Cl. H04L 1/00

(52) U.S. Cl. 713/600

(57) ABSTRACT

A clock management system includes a user interface (101), a clock manager (102), a real-time clock (104), and a CPU clock (105). The user interface is used for obtaining a current time from the clock manager, and for providing a platform for users to set a current time to the clock manager. The clock manager is provided for determining whether the set current time is valid. The real-time clock provides a current time for the clock manager. The CPU clock provides time data for the clock manager to simulate a current time. The clock manager includes a calendar module (1021) for determining whether the set current time is valid, and a daylight saving time module (1022) for advancing a current time a predetermined amount such as one hour. A related clock management method is also provided.

### BACKGROUND OF THE INVENTION

1. Field of the Invention

The present invention relates to clock management in computer systems, and particularly to a system and a corresponding method for providing various time information from different time sources.

2. Background of the Invention

It is well known that real-time clock chips in personal computers (even in expensive workstations) do not always provide the exact time. Therefore many technologies have been developed for computing devices including personal computers, workstations and other networking devices having processing units, for the purpose of achieving means for calculating time exactly.

U.S. Pat. No. 5,881,271, issued on Mar. 9, 1999, discloses a system and method for clock management. The clock management system comprises a first clock input for carrying a clock input signal having first clock cycles, a clock output for carrying an output clock signal having cycles which are synchronous with the first clock cycles, and programmable delay means. The programmable delay means receive the clock input signal, and generate the output clock signal that is delayed from the input by at least a programmable delay. The programmable delay causes the output clock signal to be synchronous with the clock input signal.

Although the above-mentioned clock management system can generate clock signals synchronous with CPU (central processing unit) clock signals, it does not ensure continuous provision of time information. In addition, the time still needs to be adjusted during daylight saving period in some zones of the world. Conventional computing systems require such adjustments to time information to be performed manually. There is no known clock management system that can automatically obtain time data from different time sources and provide time information according to different requirements of users in various locations.

### SUMMARY OF THE INVENTION

Accordingly, an objective of the present invention is to provide a clock management system and method that supplies multiple time sources to ensure provision of accurate time data.

Another objective of the present invention is to provide a clock management system and method which can provide different time data according to various requirements of users.

In order to accomplish the above-mentioned objectives, a clock management system of the present invention comprises a user interface, a clock manager, a real-time clock, and a CPU clock. The user interface is provided for obtaining a current date and time from and setting a current date and time to the clock manager. The clock manager determines whether the set date and time is valid based on time rules about a leap year, a month range, day ranges in each month and a 24-hour time range stored therein. The real-time clock provides a current date and time to the clock manager. The CPU clock generates an independent CPU clock time started from powering on of the present clock management system, the CPU clock time being provided for the clock manager to simulate a current time.

Further, a clock management method of the present invention comprises the steps of: (i) inquiring about a current time via a user interface; (ii) determining whether a real-time clock is available; (iii) if the real-time clock is available, reading a current time from the real-time clock; or (iv) obtaining a CPU clock time generated by a CPU clock if the real-time clock is not available, and simulating a current time based on the CPU clock time; (v) determining whether the current time is within a daylight saving period, and going to step (vii) directly if the current time is not within a daylight saving period; or (vi) adjusting the current time if the current time is within a daylight saving period; and (vii) returning the current time to the user interface.

Other objectives, advantages and novel features of the present invention will be drawn from the following detailed description of a preferred embodiment and method of the present invention with the attached drawings, in which:

### BRIEF DESCRIPTION OF THE DRAWINGS

FIG. 1 is a block diagram of a clock management system in accordance with a preferred embodiment of the present invention, the clock management system comprising a clock manager and a CPU clock;

FIG. 2 is a simulation algorithm table according to which the clock manager can simulate a current time based on a CPU clock time; and

FIG. 3 is a flow chart of a preferred clock management method in accordance with the present invention.

### DETAILED DESCRIPTION OF PREFERRED EMBODIMENTS OF THE INVENTION

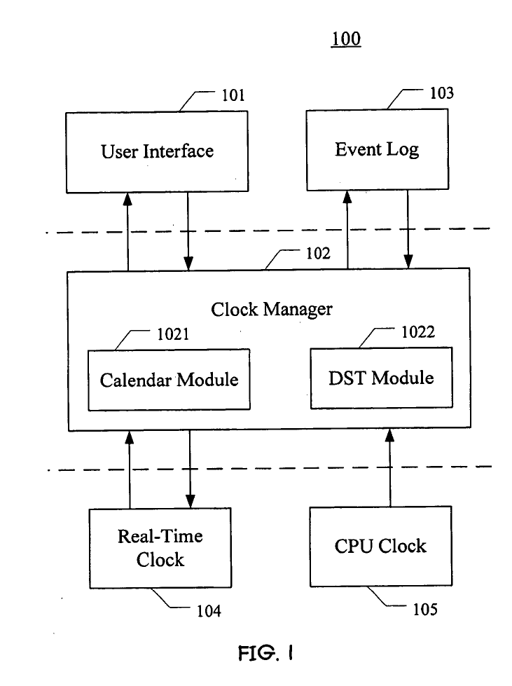

FIG. 1 is a block diagram of a clock management system 100 in accordance with the preferred embodiment of the present invention. The clock management system 100 comprises a user interface 101, a clock manager 102, an event log 103, a real-time clock (RTC) 104, and a CPU clock 105. The user interface 101 may be a command line interface (CLI) or a web browser, and is provided for obtaining a current date and time from and setting a current date and time to the clock manager 102. The clock manager 102 determines whether the set date and time is valid based on time rules about a leap year, a month range from 1 to 12, day ranges in each month and a 24-hour time range stored therein. The event log 103 can obtain a current date and time from the clock manager 102 in order to display when an event message is created. The real-time clock 104 provides a current date and time to the clock manager 102. Registers of the real-time clock 104 contain year, month, week, day, hour, minute and second data that are in 24-hour binary-coded decimal (BCD) format. The CPU clock 105 generates an independent CPU clock time that is started from a point in time when the clock management system 100 is powered on, the CPU clock time being provided for the clock manager 102 to simulate a current time.

The clock manager 102 defines a symbol (not shown) for denoting whether the real-time clock 104 is available. If the symbol denotes that the real-time clock 104 is available, the clock manager 102 retrieves a current date and time from the real-time clock 104; and when a user sets a current date and time through the user interface 101, the clock manager 102 updates the real-time clock 104 according to the set current time. If the symbol denotes that the real-time clock 104 is not available, the clock manager 102 retrieves the CPU clock time generated by the CPU clock 105 to simulate a current time.

The clock manager 102 comprises a calendar module 1021 and a daylight saving time (DST) module 1022. The calendar module 1021 is configured for checking whether the current date and time set by the user is correct, and for automatically adjusting days in a leap year and in each month according to the time rules stored in the clock manager 102. The DST module 1022 is configured for adjusting the time during a period of daylight saving time. In the present embodiment, the adjustment is advancing the time to be one hour ahead of the current time. When the DST module 1022 is enabled, a current time obtained or simulated by the clock manager 102 is advanced by one hour before it is transmitted to the user interface 101 or the event log 103. If the DST module 1022 is disabled, said current time is transmitted to the user interface 101 unaltered. The user can set enablement and disablement of the DST module 1022 through the user interface 101.

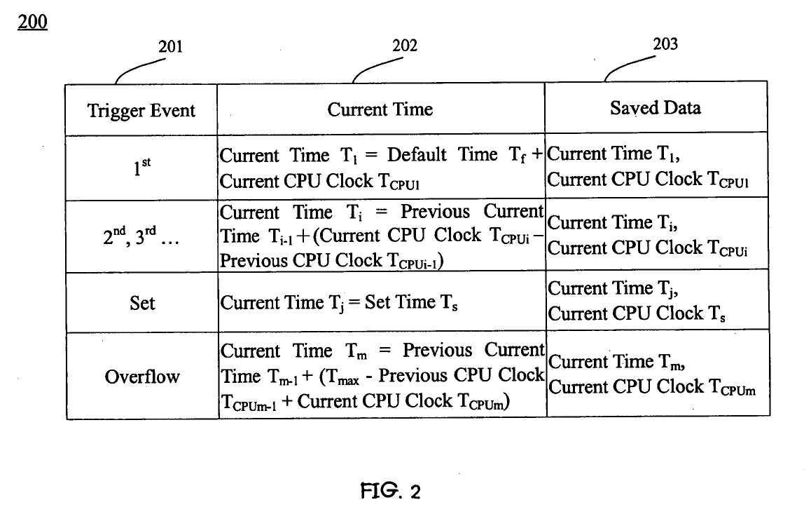

FIG. 2 is a simulation algorithm table 200 in accordance with the preferred embodiment of the present invention. The simulation algorithm table 200 is employed when the clock manager 102 retrieves the CPU clock time generated by the CPU clock 105 in order to simulate the current time. The simulation algorithm table 200 comprises three columns: trigger event 201, current time 202, and saved data 203. Trigger event 201 records those events that cause the clock manager 102 to transmit a current time to the user interface 101 or the event log 103. In trigger event 201, “1^{st}, 2^{nd}, 3^{rd}, . . . ” represent the occasions that the user queries a current time to the clock management system 100; “set” is an event in which the user sets a current time to the clock manager 102; and “overflow” means an event in which the CPU clock 105 overflows because of a count limit thereof. In the preferred embodiment of the present invention, the register of the CPU clock 105 is 32-bit in size, and the count unit is 10 milliseconds (ms). This means that a maximum count value of the CPU clock 105 is 2³², that is 4,294,967,295 counted from zero; and that the maximum CPU clock time Tₘₐₓ is 42,949,672,950 milliseconds (ms). When the count value of the register of the CPU clock 105 exceeds 4,294,967,295, i.e., every 42,949,672.950 seconds or about 497 days, the CPU clock 105 overflows. Current time 202 records a time that the clock manager 102 sends to the user at each trigger event. Saved data 203 records time data at the time of each trigger event.

The following specifications are based on the assumption that the symbol defined by the clock manager 102 denotes that the real-time clock 104 is not available, and that the CPU clock time generated by the CPU clock 105 is required to simulate a current time. When the user firstly queries a current time to the clock manager 102 via the user interface 101, the current time T₁ transmitted by the clock manager 102 to the user interface 101 is that of the default time T_{f} of the CPU clock 105, plus a current CPU clock time T_{CPU1} of the CPU clock 105. At the same time, the clock manager 102 stores the current time T₁ and the current CPU clock time T_{CPU1} in saved data 203. Thereafter, a current time Tᵢ transmitted by the clock manager 102 each time is a previous current time Tᵢ₋₁ that is stored by the clock manager 102, plus a current CPU clock time T_{CPUi} of the CPU clock 105, minus a previous CPU clock time T_{CPUi-1} of the CPU clock 105 at said previous current time Tᵢ₋₁. At said each time, the clock manager 102 stores the current time Tᵢ and the current CPU clock time T_{CPUi} in saved data 203. When the user sets a current time to the clock manager 102, a current time Tⱼ is a set time Tₛ, and the CPU clock time is configured as the set time Tₛ. At the same time, the clock manager 102 stores the current time Tⱼ and the current CPU clock time Tₛ in saved data 203. When the CPU clock 105 overflows, a current time Tₘ transmitted to the user interface 101 by the clock manager 102 is a previous current time Tₘ₋₁, plus the maximum CPU clock time Tₘₐₓ, minus a previous CPU clock time T_{CPUm-1}, plus a current CPU clock time T_{CPUm}. At the time, the clock manager 102 stores the current time Tₘ and the current CPU clock time T_{CPUm} in saved data 203. After the current time is set or after the CPU clock overflows, the second, third, . . . current time is simulated according to the calculation algorithm of said current time Tᵢ.

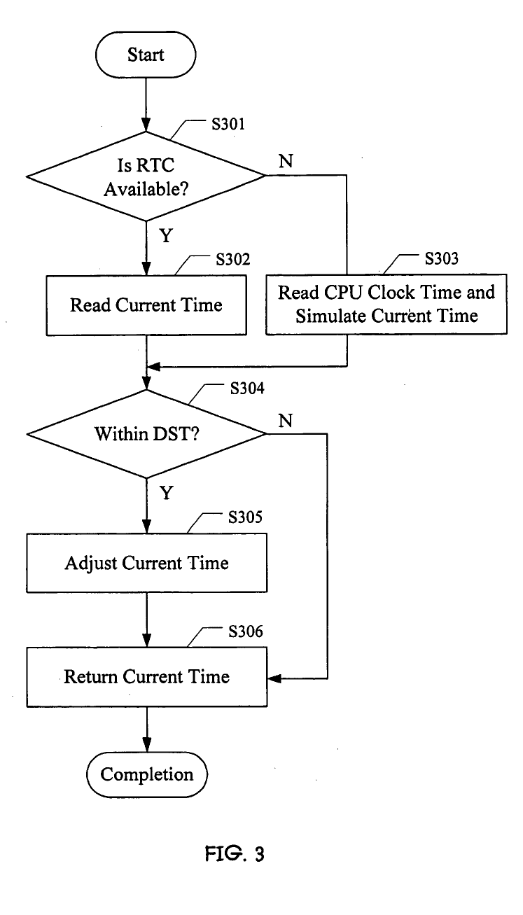

FIG. 3 is a flow chart of a preferred clock management method according to the present invention. When the user inquires about a current time to the clock manager 102 via the user interface 101, the clock manager 102 queries the symbol defined by it to determine whether the real-time clock 104 is available (step S301). If the real-time clock 104 is available, the clock manager 102 reads a current time from the real-time clock 104 directly (step S302). If the real-time clock 104 is not available, the clock manager 102 reads a CPU clock time from the CPU clock 104, and simulates a current time based on the CPU clock time according to the algorithm described above in relation to FIG. 2 (step S303). Then the DST module 1022 determines whether the current time is within a daylight saving period according to date information in the obtained current time (step S304). If the current time is not within a daylight saving period, the clock manager 102 returns the obtained current time directly to the user interface 101 (step S306). If the current time is within a daylight saving period, the DST module 1022 adjusts the obtained current time by advancing the obtained current time one hour (step S305). Then the clock manager 102 returns the adjusted current time to the user interface 101 (step S306).

Although only a preferred embodiment and method of the present invention have been described in detail above, those skilled in the art will readily appreciate that many modifications to the preferred embodiment and method are possible without materially departing from the novel teachings and advantages of the present invention. Accordingly, all such modifications are deemed to be covered by the following claims and allowable equivalents of the claims.

1. A clock management system comprising a user interface, a clock manager, a real-time clock, and a CPU (central processing unit) clock, wherein:
the user interface is provided for presenting a current time transmitted by the clock manager, and for transmitting a current time set by a user to the clock manager;
the clock manager is configured for determining whether a current time set by a user is valid, for obtaining a current time from the real-time clock, and for simulating a current time based on a CPU clock time generated by the CPU clock;
the real-time clock provides the current time for the clock manager; and
the CPU clock generates the CPU clock time for the clock manager to simulate a current time from powering on of the clock management system.

2. The clock management system as recited in claim 1, wherein the user interface comprises either or both of a command line interface and web browser.

3. The clock management system as recited in claim 1, wherein the clock manager comprises a symbol for denoting whether the real-time clock is available.

4. The clock management system as recited in claim 1, wherein the clock manager comprises a calendar module for determining whether the current time set by the user is valid, based on data on a leap year, a month range, a month range, and a time range.

5. The clock management system as recited in claim 1, wherein the clock manager comprises a daylight saving time module for adjusting a current time during a period of daylight saving time.

6. A clock management method comprising the steps of:
(a) inquiring about a current time via a user interface;
(b) determining whether a real-time clock is available;
(c) if the real-time clock is available, reading a current time from the real-time clock;
(d) determining whether the current time is within a daylight saving period, and going to step (f) directly if the current time is not within a daylight saving period;
(e) adjusting the current time if it is within a daylight saving period; and
(f) returning the current time to the user interface.

7. The clock management method as recited in claim 6, wherein step (c) further comprises the steps of:
(c1) obtaining a CPU clock time generated by a CPU clock if the real-time clock is not available; and
(c2) simulating a current time based on the CPU clock time.

8. The clock management method as recited in claim 7, wherein the simulated current time is a default time of the CPU clock, plus the CPU clock time.

9. The clock management method as recited in claim 7, wherein the simulated current time is a previous current time, plus the CPU clock time, minus a previous CPU clock time.

10. The clock management method as recited in claim 7, wherein when a user sets a time via the user interface, the current time is the set time.

11. The clock management method as recited in claim 7, wherein when the CPU clock overflows, the current time is a previous current time, plus a maximum CPU clock time, minus a previous CPU clock time, plus the CPU clock time.

12. The clock management method as recited in claim 7, wherein step (e) comprises advancing the current time one hour.

13. The clock management method as recited in claim 7, further comprising the step of:
storing the CPU clock time and the simulated current time.

14. A clock management method comprising the steps of:
(a) inquiring about a current time via a user interface;
(b) determining whether a real-time clock is available;
(c) if the real-time clock is unavailable, reading a current time from a CPU clock time generated by a CPU clock;
(d) simulating a current time based upon the CPU clock time;
(e) determining whether the simulated current time is within a daylight saving period, and going to step (g) directly if the current time is not within a daylight saving period;
(f) adjusting the current time if it is within a daylight saving period; and
(g) returning the current time to the user interface.
